(19) United States
(12) Patent Application Publication
(10) Pub. No.: US 2009/0075589 A1
(43) Pub. Date: Mar. 19, 2009

(54) Broadband range extension relay for wireless networks

(75) Inventor: Geoffrey L. Giese, Santa Clara, CA (US)

Correspondence Address: Silicon Valley Patent Group LLP, 18805 Cox Avenue, Suite 220, Saratoga, CA, 95070, US

(73) Assignee: Azure Communications Inc., Los Gatos, CA (US)

(21) Appl. No.: 12/209,560

(22) Filed: Sep. 12, 2008

Related U.S. Application Data
(60) Provisional application No. 60/972,032, filed on Sep. 13, 2007.

(51) Int. Cl. H04B 7/14

(52) U.S. Cl. 455/25

(57) ABSTRACT

A method and apparatus to extend a range of a wireless relay station (e.g., a WiMAX MMR-RS) using a first directional antenna to communicate with a base station (e.g., a WiMAX MMR-BS), to communicate with remote subscribers at a subordinate relay station using a second directional antenna, and to provide unsectorized communications to local mobile stations within the wireless relay station are provided.

### CROSS-REFERENCE TO RELATED APPLICATIONS

This application claims priority under 35 U.S.C. §119(e) to provisional U.S. Patent Application 60/972,032, titled “Broadband range extension relay for wireless networks”, filed on Sep. 13, 2007 (Attorney Docket AZU003 PV), and incorporated herein by reference in its entirety.

### BACKGROUND OF THE INVENTION

1. Field of the Invention

The invention relates generally to wireless telecommunications technology and more specifically to multihop relays in a mobile radio system.

2. Background of the Invention

In wireless network having base stations and remote subscribers, such as with WiMAX networks, coverage can be imperfect. These networks may have shadowed areas, for example, behind a hill or building, where no signal or an inadequate signal is received by a subscriber. See FIG. 1. Subscribers in these shadowed areas will not be able to communicate with the base station. The WiMAX standard defines an adaptive PHY (physical layer), where modulation and resulting throughput scales downward as SNIR (Signal power to Noise power plus Interference power Ratio) degrades. Thus, on the cell edges and in shadowed areas having a low SNIR value, resulting throughput can be severely degraded. Therefore, a need exists to improve throughput on cell edges and in shadowed areas, which would otherwise provide a low SNIR to subscribers.

### SUMMARY

A method and apparatus to extend a range of a wireless relay station (e.g., a WiMAX MMR-RS) using a first directional antenna to communicate with a base station (e.g., a WiMAX MMR-BS), to communicate with remote subscribers at a subordinate relay station using a second directional antenna, and to provide unsectorized communications to local mobile stations within the wireless relay station are provided.

Some embodiments of the present invention provide for a method of processing communications signals, the method comprising: receiving data at a first directional antenna; determining the received data contains a first message for a first subscriber in a current cell a second message for a second subscriber in a remote cell; providing an omni-directional antenna path for the first message; transmitting the first message to the first subscriber through the omni-directional antenna path; providing a directional antenna path for the second message; and transmitting the second message to the remote cell through the directional antenna path.

Some embodiments of the present invention provide for a n apparatus to increase the cell radius and performance of an MMR station, the apparatus comprising: a wireless base station; N RF directional antennas; an N+1 rotary multi-pole RF switch having a primary pole and N+1 secondary poles, wherein the primary pole is switchable to the N+1 secondary poles, and wherein the primary pole is coupled to the base station; N two-way RF switches each having a primary pole switchable, a first pole and a second pole, wherein the primary pole is switchable between the first pole and the second pole, wherein the primary pole is coupled to a respective one of the N RF directional antennas, and wherein the first pole is coupled to a respective one of a first N poles of the N+1 secondary poles of the N+1 rotary multi-pole RF switch; an N-way RF power divider having a primary terminal and N secondary terminals, wherein the primary terminal is couple a last secondary pole of the N+1 rotary multi-pole RF switch, and wherein each of the N secondary terminals are couple to a respective one of the secondary poles of the N two-way RF switches; and a controller to control sequencing of the N two-way RF switches and the N+1 rotary multi-pole RF switch.

Some embodiments of the present invention provide for a n MMR relay station for processing communications signals, the MMR relay station comprising: means for receiving data at a first directional antenna; means for determining the received data contains a first message for a first subscriber in a current cell a second message for a second subscriber in a remote cell; means for providing an omni-directional antenna path for the first message; means for transmitting the first message to the first subscriber through the omni-directional antenna path; means for providing a directional antenna path for the second message; and means for transmitting the second message to the remote cell through the directional antenna path.

Some embodiments of the present invention provide for a n MMR relay station for processing communications signals, the MMR relay station comprising: a receiver coupled to a first directional antenna and an omni-directional antenna, wherein the receiver comprises circuitry to demodulate signals into received data; a processor coupled to the receiver, wherein the processor comprises logic to determine whether the received data contains a first message for a first subscriber in a current cell and to determine whether the received data contains a second message for a second subscriber in a remote cell; a controller, wherein the controller schedules transitions of received messages; selects a transmission path between the omni-directional antenna path and the directional antenna path; provides an omni-directional antenna path for transition of the first message; and provides a directional antenna path for transition of the second message; and a transmitter selectively coupled between the omni-directional antenna path and the directional antenna path.

These and other aspects, features and advantages of the invention will be apparent from reference to the embodiments described hereinafter.

### BRIEF DESCRIPTION OF THE DRAWINGS

Embodiments of the invention will be described, by way of example only, with reference to the drawings.

FIG. 1 shows a WiMAX Adaptive PHY network.

FIG. 2 shows an MMR-RS with omni-directional antenna where the MMR-RS cannot communicate directly with the MMR-BS.

FIG. 3 illustrates an MMR-RS located close enough to communicate directly with an MMR-BS.

FIG. 4 illustrates an MMR-BS and two MMR-RS communicating to the cell edge of the MMR-BS.

FIG. 5 illustrates an MMR-RS having a high-gain directional antenna operating within a coverage area an MMR-BS.

FIG. 6 shows an MMR-RS having antenna pattern extending to the cell edge of the MMR-BS, in accordance with some embodiments of the present invention.

FIG. 7 shows a sectorized MMR-RS antenna scheme, in accordance with some embodiments of the present invention.

FIG. 8 shows a first MMR-RS within an MMR-BS coverage area and a second MMR-RS extension outside the MMR-RS and MMR-BS coverage areas, in accordance with some embodiments of the present invention.

FIGS. 9A and 9B illustrate WiMAX frames as seen at an MMR-BS.

FIG. 10 is a schematic diagram of RF paths in an MMR-RS having three sectorized antennas, in accordance with some embodiments of the present invention.

FIG. 11 shows a flowchart for a broadband mobile multihop relay range extender, in accordance with some embodiments of the present invention.

### DETAILED DESCRIPTION OF THE INVENTION

In the following description, reference is made to the accompanying drawings, which illustrate several embodiments of the present invention. It is understood that other embodiments may be utilized and mechanical, compositional, structural, electrical, and operational changes may be made without departing from the spirit and scope of the present disclosure. The following detailed description is not to be taken in a limiting sense. Furthermore, some portions of the detailed description that follows are presented in terms of procedures, steps, logic blocks, processing, and other symbolic representations of operations on data bits that can be performed in electronic circuitry or on computer memory. A procedure, computer executed step, logic block, process, etc., are here conceived to be a self-consistent sequence of steps or instructions leading to a desired result. The steps are those utilizing physical manipulations of physical quantities. These quantities can take the form of electrical, magnetic, or radio signals capable of being stored, transferred, combined, compared, and otherwise manipulated in electronic circuitry or in a computer system. These signals may be referred to at times as bits, values, elements, symbols, characters, terms, numbers, or the like. Each step may be performed by hardware, software, firmware, or combinations thereof.

The figures described below show various MMR implementations using omni-directional and directional antennas. The relative dimensions are illustrative only and not meant to be limiting.

To increase a subscriber's SNIR and to improve throughput on cell edges and in shadowed areas, a network provider may use sector fill-in and/or remote radio heads (distributed antenna systems). While both of these solutions are viable, they may also be relatively expensive.

With sector fill-in, a small, inexpensive WiMAX micro base station is placed within the shadowed area or cell edge. Such sector fill-ins may increase SNIR but also require a backhaul, which may be expensive. The backhaul can be implemented in a variety of methods. For example, a network operator may use Ethernet or DS-3 connections via a leased line or a microwave radio. The initial costs of implementing a microwave backhaul link may be excessively expensive. The operational expenditure due to the recurring leased line costs may dwarf the cost of the hardware itself. For example, a DS-3 leased line may cost approximately $2500 per month. Amortizing a WiMAX fill-in micro base station over an expected 10 year lifetime equates to approximately $300 k per sector fill-in radio.

A dense urban environment may require sector fill-in micro base stations every 250 meters (0.25 km). For example, a small city having an urban area of 22 km² will require over 350 (=22 km²/(0.25 km)²) sector fill-in micro base stations. Over a decade, operating expenditures for the backhauls may total $105M (=$2500 per DS-3×350 sector fill-in base stations×12 months per year×10 years). An approximate hardware costs of such a network may be only $1.75M ($5 k per micro base station*350 base stations). Therefore, concentrating on minimizing the recurring costs may substantially minimize overall lifetime costs.

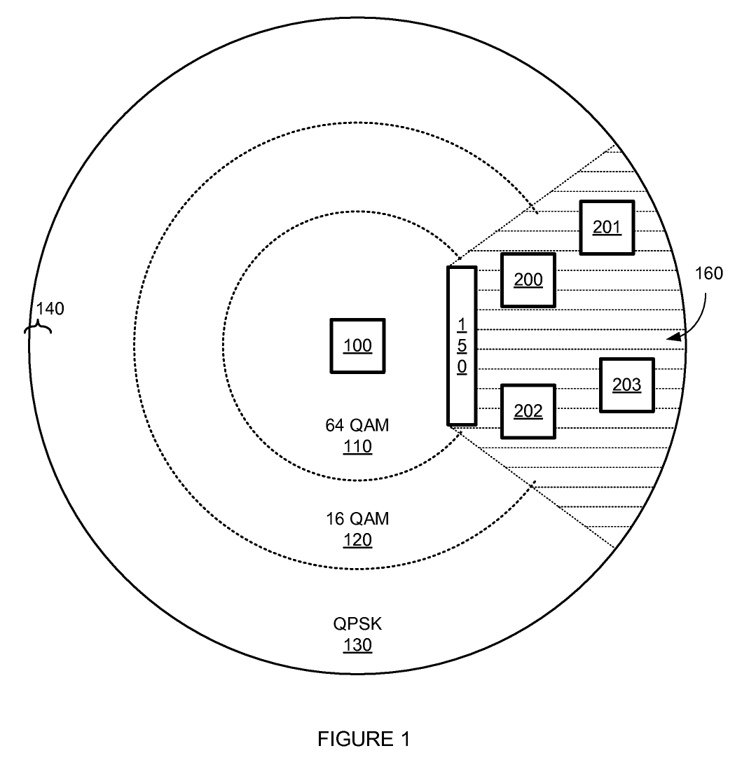

FIG. 1 shows a WiMAX Adaptive PHY network in an MMR (Mobile Multihop Relay) environment, including an MMR-BS (MMR enabled base station) 100 and a number of MMR-RSs (MMR enabled relay stations) 200-203. MMR is a superset of the IEEE 802.16e mobile WiMAX specification developed as IEEE 802.16 TGj (Task Group j). MMR provides sector fill-in and has the unique property of not requiring a backhaul. MMR functions as a relay between a subscriber and a base station.

The figure also shows a fringe area or a cell edge 140 at the cell boundary. The MMR-BS 100 provides its highest throughput (e.g., 64 QAM) within a center area 110 closest to the MMR-BS 100. As signals degrade and SNIR lower, the MMR-BS 100 may provide an intermediate level of throughput (e.g., 16 QAM) within an intermediate ringed area 120 outside of the center ring 110. Within an outer ringed area 120 farthest from the center, the MMR-BS 100 may provide its lowest level of throughput (e.g., QPSK).

The figure also shows an obstruction 150, which created a shadow area 160. A subscriber, such as a mobile subscriber (MS) or a subscriber station (SS), are along a cell edge 140 or in shadows areas 160, an MMR-BS 100 can no longer effectively communicate directly with the subscriber. Messages destined for such a subscriber may be communicated via an MMR-RS 200 and specially tagged for retransmission by the MMR-RS 200. The MMR-RS 200 providing signals having an adequate SNIR to the subscriber then retransmits these messages within its local cell coverage area to the hidden subscriber. A hidden subscriber otherwise having low SNIR, and at best low throughput using QPSK modulation, are provided higher SNIR and resulting higher throughput, for example using 64 QAM modulation. A higher SNIR is highly beneficial both to a network operator wanting to provide the best possible network coverage as well as the subscribers who need high quality, high throughput signals.

A network architecture model having MMR-RSs using relay communications, instead of having fill-in base stations requiring expensive backhaul paths, substantially reduces recurring operational expenditures and hardware costs described above. A benefit of using MMR technology from a network operator's perspective is the fact that MMR provides self-backhauling without affecting cell throughput and without requiring a separate Ethernet or microwave link.

A design factor associated with MMR technology is the number of hops used to communicate between an MMR-BS 100 and a subscriber. Another design factor is the cell radius of an MMR-RS 200. First, though the current IEEE 802.16j standard calls for a minimum of two hops (i.e., two MMR-RSs in cascade), practical issues of latency and delay preclude more than two hops. For voice over Internet protocol (VoIP) traffic, the delay introduced by more than two hops may be too excessive for such digital voice communications. If the MMR-RS 200 cell radius is small with respect to the main MMR-BS 100 cell radius, it may require several MMR-RSs 200 to reach the cell edge. The resulting several hops would preclude time-sensitive applications such as real-time voice and video applications.

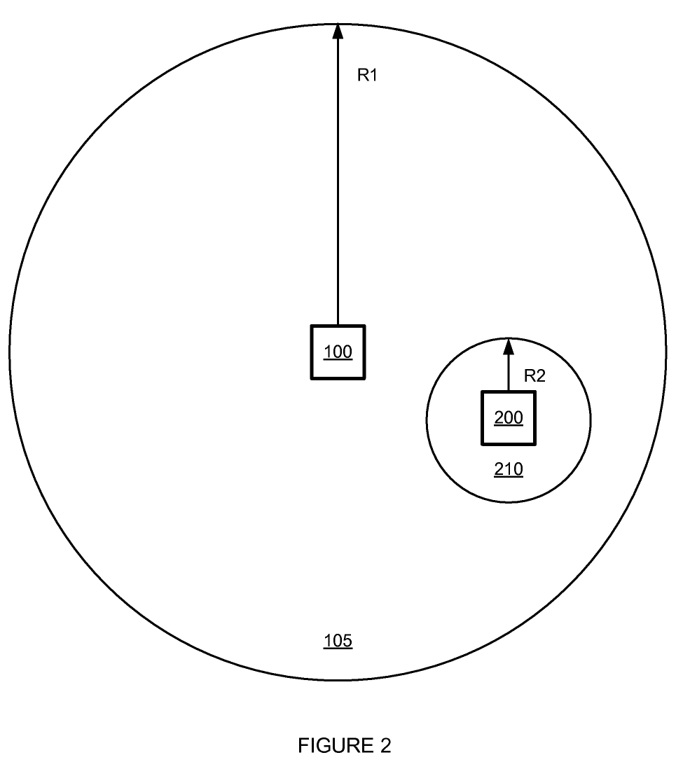

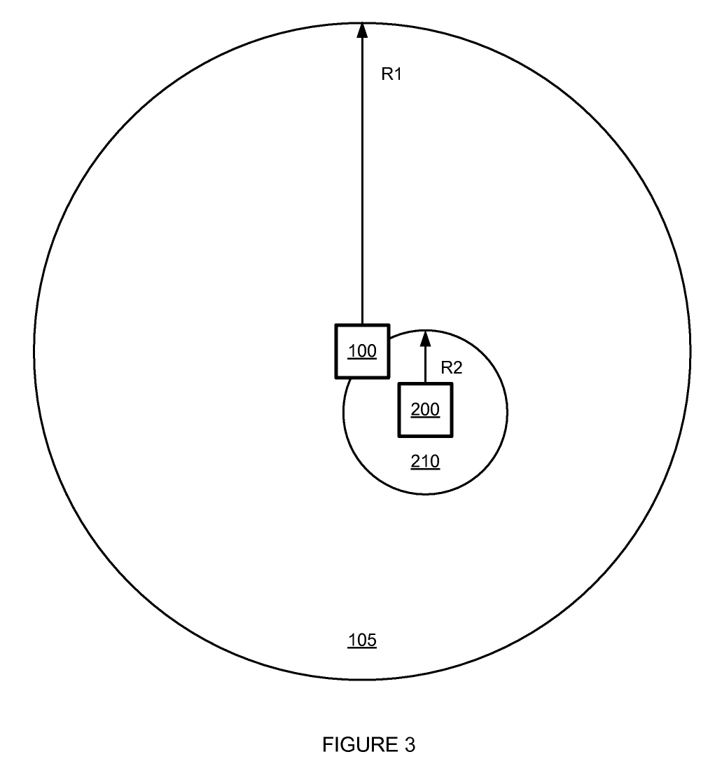

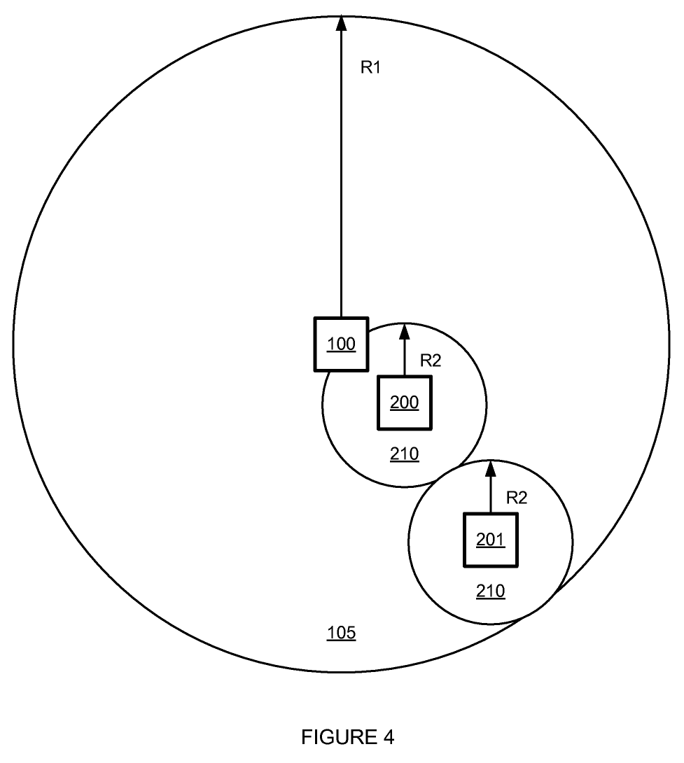

FIG. 2 shows an MMR-RS 200 with omni-directional antenna providing a range of RI and a coverage area 105, however, the MMR-RS 200 cannot communicate directly with the MMR-BS 100. In this non-working network topology, an omni-directional antenna used by the MMR-RS 200 can receive signaling from both the MMR-BS 100 and hidden mobile subscribers. In situation where an MMR-RS 200 has a low-gain omni-directional antenna, the cell radius R2 of the MMR-RS 200 (providing a local coverage area 210) may be so small that signals from the MMR-RS 200 can not reach the MMR-BS 100. Such a network topology is effectively non-functional because there is no uplink from the MMR-RS 200 to the MMR-BS 100. To fix the topology, the MMR-RS uplink range R2 to the MMR-BS 100 needs to be increase, the MMR-RS 200 needs to be repositioned closer to the MMR-BS 100 (see FIG. 3), and/or additional MMR-RSs 200 need to be added (see FIG. 4).

FIG. 3 illustrates an MMR-RS 200 located close enough to communicate directly with an MMR-BS 100. The MMR-RS 200 is close enough to the MMR-BS 100 such that the cell radius R2 of the MMR-RS 200 captures the MMR-BS 100. The topology shown may assist with shadowed areas 160 but is non-functional for cell edges 140 of the MMR-BS 100. One feature of MMR is that high throughput, high quality signals may be replace the weak signal from the MMR-BS at cell edges 140, however, the topology of FIG. 3 does not utilize this feature.

FIG. 4 illustrates an MMR-BS 100 and two MMR-RS 200 and 201 communicating to the cell edge of the MMR-BS 100. The MMR-RS topology includes a first MMR-RS 200 (a superordinate MMR-RS) and a second MMR-RS 201 (a subordinate MMR-RS) both within the coverage area 105 of an MMR-BS 100. A subordinate MMR-RS is an MMR-RS whose connection to an MMR-BS 100 is through another MMR-RS, called a superordinate MMR-RS. Similarly, a superordinate MMR-RS is an MMR-RS that connects to an MMR-BS 100 and also acts as to relay communications to one or more subordinate MMR-RSs. An MMR-RS (not shown) may act as a superordinate MMR-RS to one MMR-RS and as a subordinate MMR-RS to another MMR-RS. Such relay stations are described in greater detail below.

The topology shows a two-hop solution to provide coverage out to a cell edge of the MMR-BS 100. Signals destined from the MMR-BS 100 to a subscriber in a subordinate MMR-RS 201 (farther from the MMR-BS 100) must first pass through a superordinate MMR-RS 200 (closer to the center of the MMR-BS 100). The addition of the second hop, however, introduces additional delay that may be especially noticeable for real-time applications. This topology is further impacted if a third MMR-RS, acting as another subordinate MMR-RS, is added at a position more distant from the MMR-BS 100. The resulting additional hop to a subscriber within the third MMR-RS will lead to additional unwanted latency and delay.

For illustrative purposes, FIG. 4 shows an MMR-RS 200 cell having a radius R2=R1/4, where R1 is the radius of the MMR-BS 100. Often though, MMR-RS cells having omni-directional radios will have a relatively much smaller radius such that it may take several hops, perhaps five or more, to reach the cell edge of the MMR-BS 100. Each additional MMR-RS will add additional unwanted latency and delay.

In a first solution to reduce the latency, an MMR-RS 200 uses a high-gain omni-directional antenna to increase its radius R2 to extend the coverage area to the cell edge of the MMR-BS 100. A sufficient omni-directional antenna, however, may be very expensive. An expected price for an MMR-RS is about $3000 but an omni-directional antenna with sufficient gain to provide coverage to the cell edge may cost $1000 or more. This increased cost would have a deleterious effect on profit models and overall cost of network deployment. Thus, from a cost standpoint, a high-gain omni-directional antenna may not be desirable.

In a second solution to reduce the latency, the distance R2 (the MMR-RS 200 cell radius) is equal to the radius R1 of the MMR-BS 100, for example by employing a high-gain directional antenna at the MMR-RS 200. Such replacement high-gain directional antenna may be purchased or designed inexpensively at a lower cost than an omni-directional antenna. Unfortunately, if the MMR-RS 200 directs its high-gain directional antenna towards the MMR-BS 100, it may lose coverage with some of the subscribers within its own cell area 105.

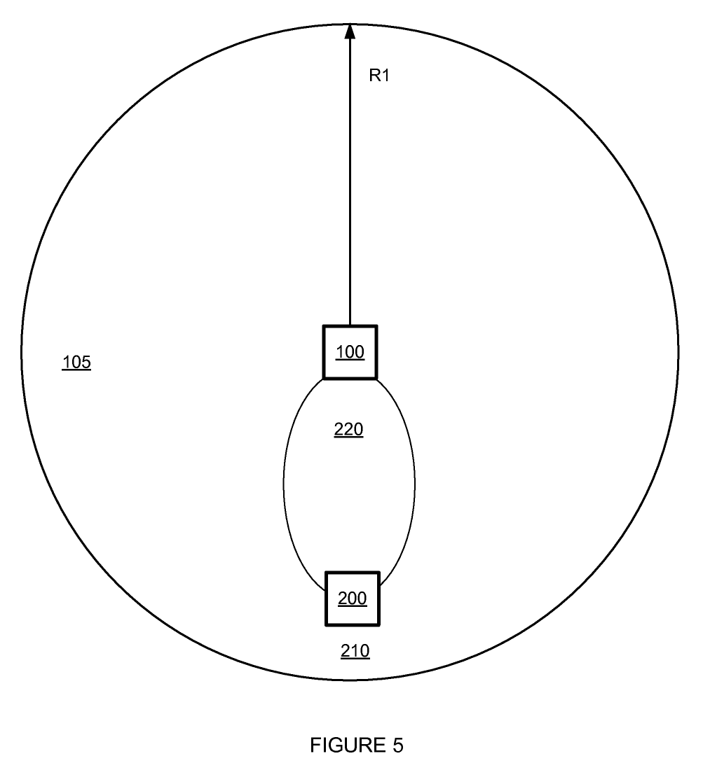

FIG. 5 illustrates an MMR-RS 200 having a high-gain directional antenna (covering area 220) operating within a coverage area 105 of an MMR-BS 100. A single directional antenna being used by the MMR-RS 200 causes a first subscriber within the pattern 220 of the directional antenna to have coverage by the MMR-RS 200, however, subscribers outside of the directional antenna's pattern 220 would be unable to communicate with either the MMR-RS 200 or the MMR-BS 100, if in a shadowed area.

Thus, in accordance with some embodiments of the present invention, an MMR-RS 200 has omni-directional coverage 210 when communicating with a subscriber but has directional coverage 220 when communicating with an MMR-BS 100 or another MMR-RS.

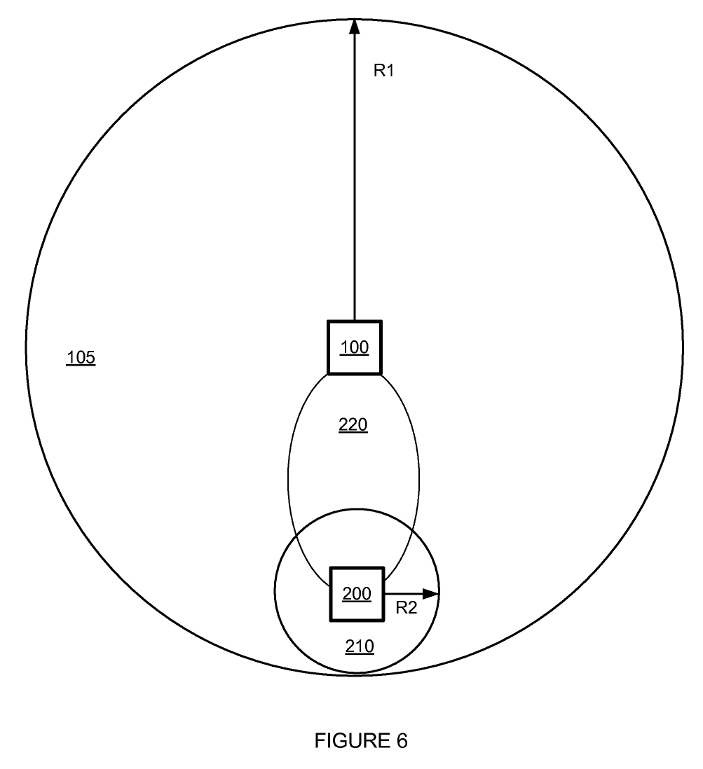

FIG. 6 shows an MMR-RS 200 having antenna pattern extending to the cell edge of the MMR-BS 100, in accordance with some embodiments of the present invention. The MMR-RS 200 has both and an omni-directional antenna (providing a coverage area 210 to subscribers) and a high-gain directional antenna (providing a coverage 220 to the MMR-BS 100). The MMR-RS 200 may use the high-gain directional antenna when communicating with the MMR-BS 100 or a subordinate MMR-RS. The high-gain directional antenna also allows the MMR-RS 200 to have an effective radius equivalent in distance to the radius R1 of the MMR-BS 100.

When communicating with subscribers within the cell radius R2 of the MMR-RS 200, the MMR-RS 200 uses a low gain omni-directional antenna providing coverage area 210. By using an omni-directional antenna rather than a sectorized or directional antenna, the MMR-RS 200 reduced complexity of the MMR-RS 200. For example, a need for complicated intelligence (e.g., power control algorithms, subscriber location algorithms, tracking algorithms to plot trajectories of moving subscribers), which would be otherwise needed in a sectorized cell, may be reduced or eliminated. Thus, by using an omni-directional antenna to communicate with subscribers, complexity and cost may be reduced.

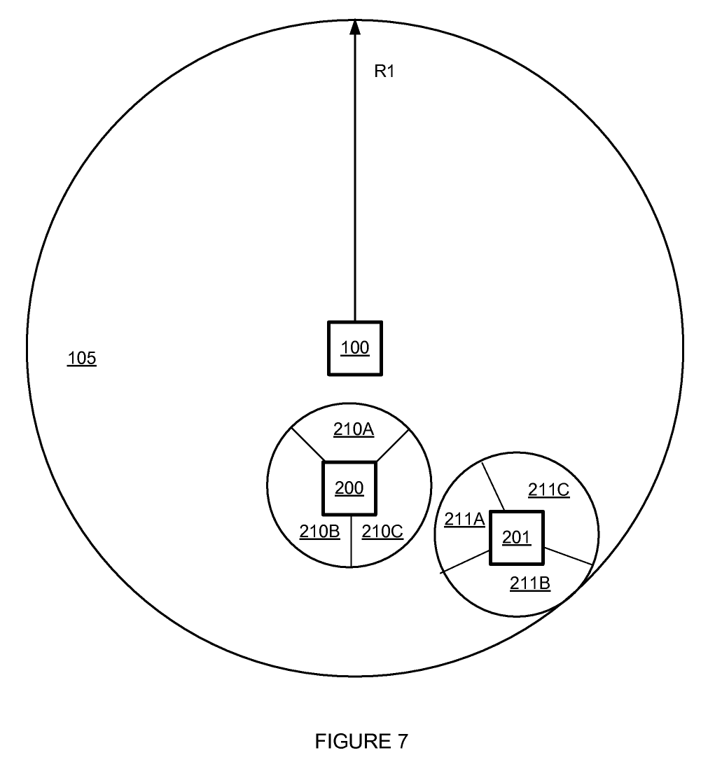

FIG. 7 shows a sectorized MMR-RS antenna scheme, in accordance with some embodiments of the present invention. A first MMR-RS 200 and a second MMR-RS 201 are both within the coverage area 105 of the MMR-BS 100. In a multi-hop MMR deployment, MMR-RS 200 may be sectorized into three sectors (210A, 210B & 210C) and can communicate with the MMR-BS 100 (via sector 210A) and MMR-RS 201 (via sector 210C). MMR-RS 201 is also sectorized into three sectors (211A, 211B & 211C) and communicates with MMR-RS 200 (via sector 211A) but is block in this example from directly communicating with the MMR-BS 100.

When MMR-RS 200 needs to communicate with the MMR-BS 100 to send and receive messages from and to the subscribers within the coverage area 210A of MMR-RS 200, a first sector directional antenna may be activated. This provides a long distance MMR cell radius as described above. When MMR-RS 200 needs to relay messages to MMR-RS 201, a third sector directional antenna may be activated. This allows a high quality, high throughput link between MMR-BS 100 and subordinate MMR-RS 201 via superordinate MMR-RS 200. These reliable links will communicate WiMAX PDUs (packet data units), also called a WiMAX packets, which are similar to Ethernet packets. Switching between sectors will be determined by recognizing each WiMAX PDU destination. For example, a packet from a subscriber or a subordinate MMR-RS 201 that is destined for the MMR-BS 100 will be transmitted from the first directional antenna (covering area 210A) of the superordinate MMR-RS 200. A packet from the MMR-BS 100 destined for the subordinate MMR-RS 201 will be transmitted from the third sector directional antenna of the superordinate MMR-RS 200.

Sectors of a MMR-RS that are not being used to communicate to the MMR-BS 100 or to other MMR-RSs may be unnecessary. These sectors (such as 210B) may be eliminated, left powered down and unused, used in the future to expand communication to a new subordinate MMR-RS, or used to communicate with subscribers.

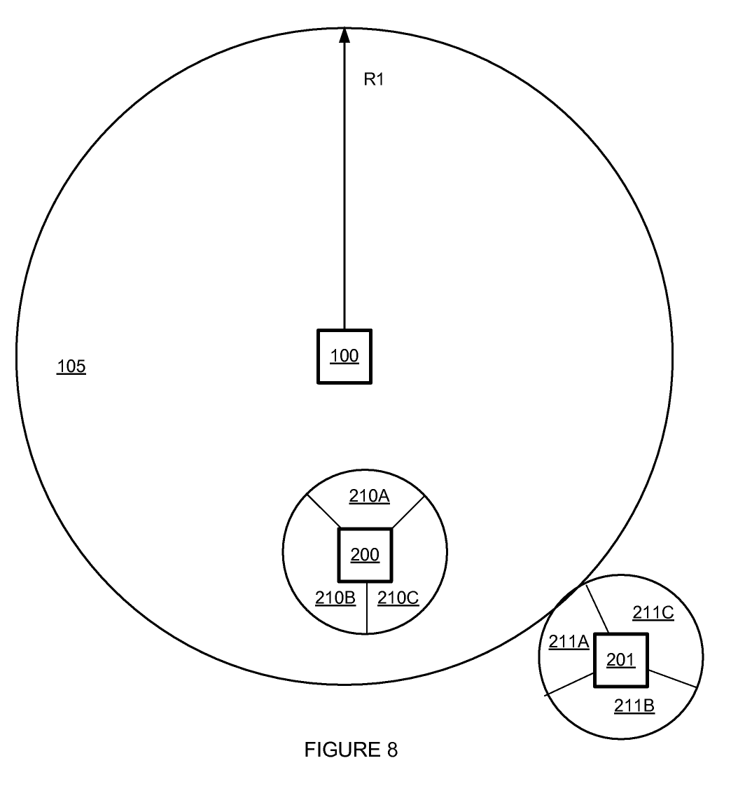

FIG. 8 shows a first MMR-RS 200 within an MMR-BS 100 coverage area 105 and a second MMR-RS 201 extending outside the MMR-RS 200 and MMR-BS 100 coverage areas, in accordance with some embodiments of the present invention. This topology may provide a longer MMR cell radius whereby a main MMR-BS 100 having radius R1 is extended to outlying areas. Such a topology uses more than just omni-directional antennas or just a single directional.

If this network topology was implemented with commercial low-gain omni-directional antennas, a number of MMR-RSs would need to be daisy chained resulting in an excessive number of hops to reach subscribers in the most distant cell (MMR-RS 201). Excessive delays may severely impact real-time applications such as real-time voice and video. The embodiment shows MMR-RSs 200 and 201, where each MMR-RS uses an omni-directional antenna when communicating with subscribers and directional antennas to communicate to an MMR-BS 100 or another MMR-RS.

Some embodiments of the MMR-RS 200 include three 120-degree sectorized directional antennas with a nominal gain of 15 to 18 dB. In typical scenarios, this configuration may provide a free space radius of over 1 mile with over 15 dB of fade margin. With an output power of 500 mW (+27 dBm), the equivalent or effective isotropically radiated power (EIRP) of this system will be 45 dBm, which is similar to an MMR-BS WiMAX macro base station. Thus, an MMR-RS cell radius may be equivalent to an MMR-BS cell radius.

The specified parameters are provided as examples. Other ranges and antenna sectorization configurations as well as various operating frequency may be used. That is, the specific numbers cited here are exemplary and one skilled in the art of radio frequency (RF) network design may employ antennas having higher gain, an increased number of sectors and different operating frequencies.

A series of RF switches may be employed to switch among the multiple antennas. A received WiMAX burst will be to inspect for the specially tagged WiMAX PDUs that are: (1) coming from the network and destined for a subscriber; or (2) coming from either a subscriber or another MMR-RS and to be relayed to other MMR-RS. The switches will switch in time over the WiMAX frame as needed.

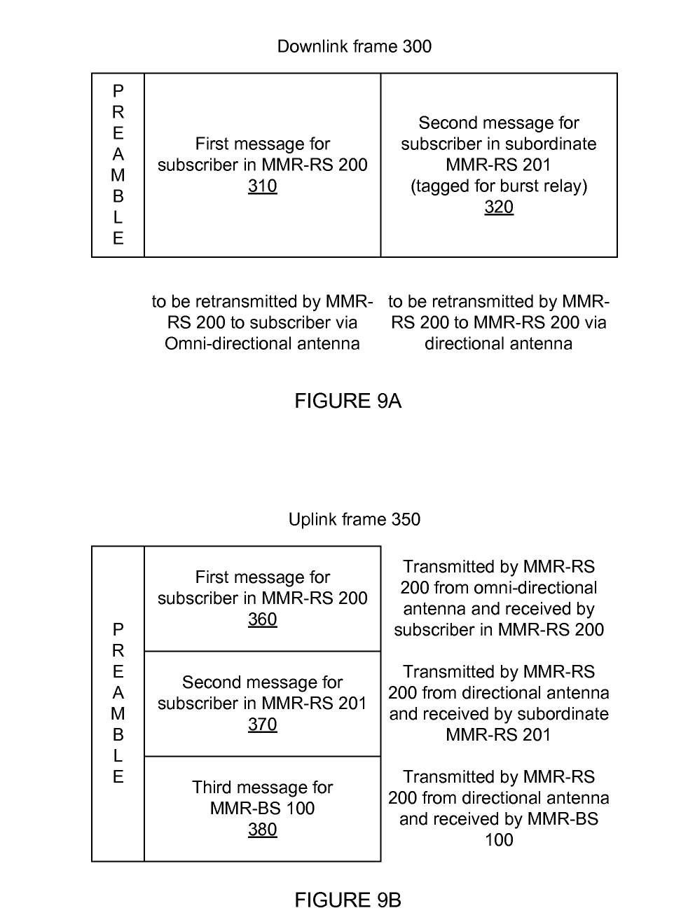

FIGS. 9A and 9B illustrate WiMAX frames as seen at an MMR-BS 100. FIG. 9A depicts a typical downlink frame transmitted by MMR-BS 100 and received by MMR-RS 200 via its directional antenna.

PDUs may be specially tagged as MMR bursts for relaying. When PDUs are relayed, antennas will switch as described above. For example, one sector may be active for reception of a downlink frame 300 (from the MMR-BS 100 to the MMR-RS 200). The MMR-RS 200 will act as a router. That is, some PDUs will be dropped and other PDUs will be relayed. For example, a PDU assumed to be received by a subscriber within the MMR-BS 100 coverage area 105 will dropped (i.e., ignored and not retransmitted). On the other hand, a PDU marked for retransmission to either a subscriber (e.g., PDU 310) or to a subordinate MMR-RS 201 (e.g., PDU 320) will be retransmitted.

For example, a first PDU 310 is destined for a subscriber within the coverage area of the MMR-RS 200. The MMR-RS 200 identifies the need to retransmit this PDU 310 directly to the subscriber via an omni-directional antenna. A second PDU 320 is destined to a different subscriber within a subordinate MMR-RS 201. This PDU 201 is then scheduled for retransmission to the subordinate MMR-RS 201 via a sectorized antenna. As such, the MMR-RS holds PDU that are to be retransmitted until the next available and appropriate (omni-directional or sectorized) slot is available.

FIG. 9B depicts a typical uplink frame transmitted by MMR-RS 200 and received by subscriber, the MMR-RS 201 and the MMR-BS 100. After receipt of the downlink frame 300, the MMR-RS 200 may retransmit one or more uplink frames 350 including PDUs it received from the MMR-BS 100. When retransmitting a PDU directly to a subscriber hidden from the MMR-BS 100, the MMR-RS 200 activates its omni-directional antenna. For example, the first message 310 received in the downlink frame 300 may be retransmitted as a first message for the subscriber in the coverage area of the MMR-RS 200. This first message would be transmitted by the omni-directional antenna of the MMR-RS 200.

The MMR-RS 200 may also act as a superordinate MMR-RS and relays PDU 320 received on the downlink to subordinate MMR-RS 201. During traffic transmitted to a subordinate MMR-RS 201, the superordinate MMR-RS 200 disabled the omni-directional antenna transmissions and activates the directional antenna. If multiple directional antennas are available, the MMR-RS 200 activates the directional antenna directed towards the subordinate MMR-RS 201, thus allowing a high gain, high quality signal to be received by the subordinate MMR-RS 201.

In some embodiments, the RF hardware includes a printed three-way Wilkinson power divider. When operating in omni-directional mode, RF switches route the main RF signal to the power divider, which divides the signal 3 ways. The Wilkinson power divider is exemplary and may be replaced by a multitude of technologies and methods to obtain low or non-resistive power splitters. Wilkinson power dividers are referenced here due to their ease of layout in standard printed circuit boards. One skilled in the art could, however, could replace the Wilkinson power divider with toroid type divider or other type of divider.

When a specific sector antenna is activated, the power divider is switched out of the circuit and bypassed. The RF switches provide a low-loss path to any of the desired sector antennas.

Because MMR may be deployed in a MIMO configuration, schematics and images in this document use MIMO antennas. That is, two antennas for each sector with a first antenna polarized vertically and the second antenna polarized horizontally. The same scheme could be used in a SISO configuration, or may be deploy using an MMR with MIMO.

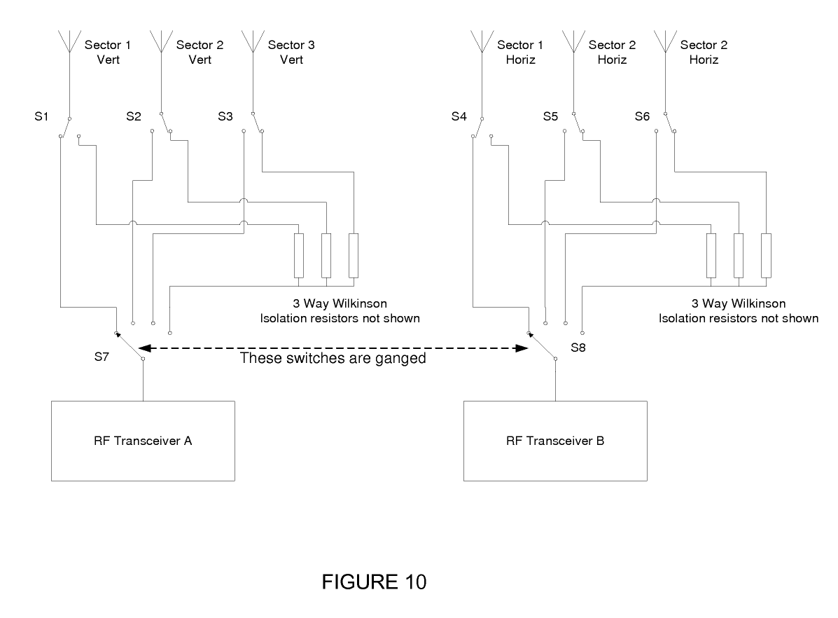

FIG. 10 is a schematic diagram of RF paths in an MMR-RS having three sectorized antennas, in accordance with some embodiments of the present invention. The exemplary schematic diagram for a MIMO implementation shows the antennas, switches, power divider and RF transceivers. The 3-way Wilkinson power dividers will be engaged during bursts where messages are transmitted to a subscriber. In this way, the three antennas act as one omni-directional antenna. The schematic as illustrated shows the switches in the state to transmit from the MMR-RS to the MMR-BS from the first sector (Sector 1). Switches S1 and S4 are ON, switches S2, S3, S5 and S6 are OFF, and switches S7 and S8, which are ganged together, are both in position 1.

A non-resistive power divider provides better performance than many off-the-shelf omni-directional antennas. Many economical omni-directional antennas provide unity gain or 0 dBi. In the solution presented here, the loss due to the Wilkinson power divider is about 5 dB. Reuse the numbers for an antenna gain of 18 dB, the solution is operating in an omni-directional mode, the effective gain is 18 dB−5 dB=13 dB. In this example, the omni-directional antenna would have a cell radius of at least five times more than a 0-dBi commercial omni-directional antenna. These antenna gain values as well as the number of sectors are exemplary. A skilled engineer would understand how to modify the parameters in accordance with the present invention.

The following truth tables define states for proper functionality of the example circuit of FIG. 10. Additional sectors would require expanded truth tables.

TABLE 1
Transmitting from the MMR-RS 200 to MMR-BS 100 and to subordinate
MMR-RS 201, both in Sector 1 (210A from FIG. 7).

| Switch | State |
|---|---|
| S1 | ON |
| S2 | OFF |
| S3 | OFF |
| S4 | ON |
| S5 | OFF |
| S6 | OFF |
| S7 | Position 1 |
| S8 | Position 1 |

TABLE 2
Transmitting from the MMR-RS 200 to MMR-BS 100 and to subordinate
MMR-RS 201, both in Sector 2 (210B from FIG. 7).

| Switch | State |
|---|---|
| S1 | Off |
| S2 | On |
| S3 | Off |
| S4 | Off |
| S5 | On |
| S6 | Off |
| S7 | Position 2 |
| S8 | Position 2 |

TABLE 3
Transmitting from the MMR-RS 200 to MMR-BS 100 and to subordinate
MMR-RS 201, both in Sector 3 (210C from FIG. 7).

| Switch | State |
|---|---|
| S1 | Off |
| S2 | Off |
| S3 | On |
| S4 | Off |
| S5 | Off |
| S6 | On |
| S7 | Position 3 |
| S8 | Position 3 |

TABLE 4
Transmitting from the MMR-RS 200 to one or more subscribers in
any sector (210A, 210B & 210C) to operate in an omni-directional mode

| Switch | State |
|---|---|
| S1 | On |
| S2 | On |
| S3 | On |
| S4 | On |
| S5 | On |
| S6 | On |
| S7 | Position 4 |
| S8 | Position 4 |

Embodiments of the present invention reduce or eliminate the need for an MMR-RS 200 to have a backhaul link unlike known systems. The use of directional antennas between superordinate and subordinate MMR-RSs allows for greater distances to be covered while minimizing the number of hops to a subscriber. The use of omni-directional antennas when communicating with subscribers reduced the need complex software needed to handle intercell issues described above.

In some embodiments of the present invention, an MMR-RS 200 has a cell radius R1 (an MMR-BS cell radius) such that it may communicate with the MMR-BS. The ability to extend coverage outside the main MMR-BS cell are has been solved without introducing unnecessary delay. The need to have omni-directional coverage when the MMR-RS 200 communicates with the hidden subscribers within the MMR-RS cell has been provided. The embodiments disclosed herein provide significantly more gain when operating in the omni-directional mode than a commercial omni-directional antenna, thereby increasing the omni-directional cell radius significantly.

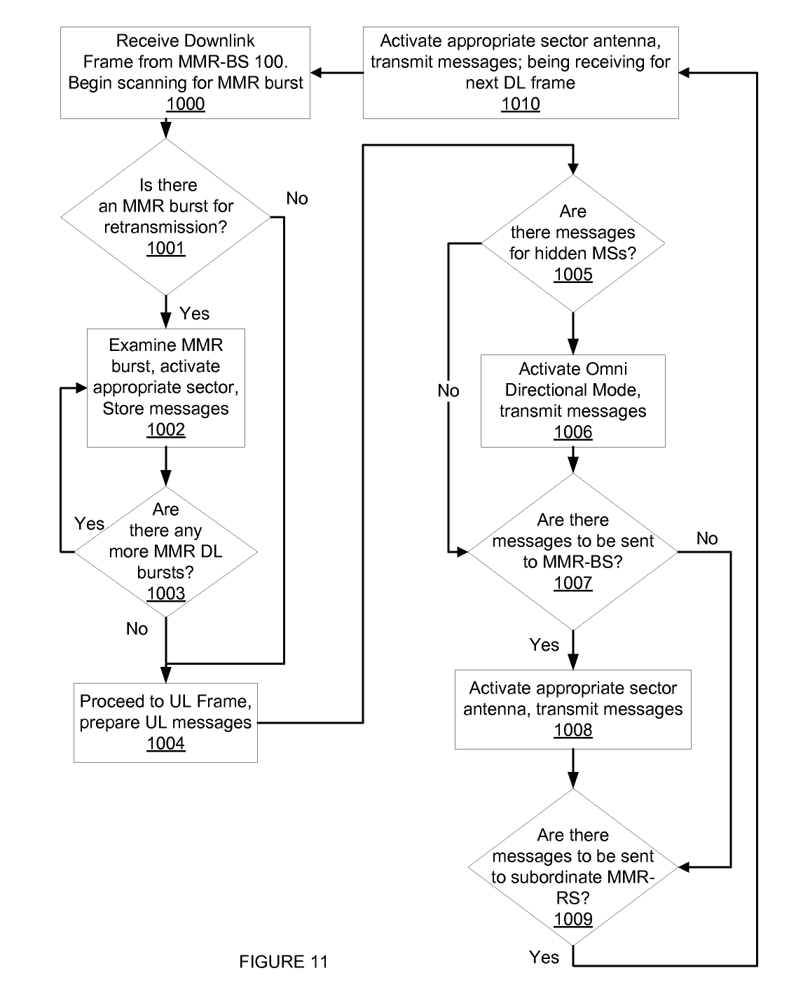

FIG. 11 shows a flowchart for a broadband mobile multihop relay range extender, in accordance with some embodiments of the present invention. At 1000, an MMR-RS receives a downlink frame from an MMR-BS 100 and begins scanning for MMR bursts. At 1001, the MMR-RS makes a determination as to whether there is an MMR burst for retransmission. If a burst for retransmission exits, the MMR-RS proceeds to 1002 and if not to 1005. At 1002, the MMR-RS examines the MMR burst and activates the appropriate sector then continues to 1003. At 1003, the MMR-RS determines whether or not there are any more MMR DL (downlink) bursts. If there are more MMR DL bursts, the MMR-RS returns to 1002 otherwise it proceeds to 1004. At 1004, the MMR-RS proceeds to transmit an UL (uplink) frame and prepares an UL messages then proceeds to 1007.

At 1005, the MMR-RS determines whether or not there are messages for one or more hidden subscribers. If there are messages, the MMR-RS proceeds to 1006 and if not skips 1006 and proceeds to 1007. At 1006, the MMR-RS activates an omni-directional mode and transmits one or more messages. Next at 1007, the MMR-RS determines whether or not there are messages to be sent to an MMR-BS. If there are messages, the MMR-RS proceeds to 1008 and otherwise it skips to 1009. At 1008, the MMS-RS activates an appropriate sector antenna and transmits one or more messages. Next at 1009, the MMR-RS determines whether or not there are messages to be sent to a subordinate MMR-RS. If so, the MMR-RS proceeds to 1010 and if not it returns to 1000 to begin to receive the next DL frame.

The description above provides various hardware embodiments of the present invention. Furthermore, the figures provided are merely representational and may not be drawn to scale. Certain proportions thereof may be exaggerated, while others may be minimized. The figures are intended to illustrate various implementations of the invention that can be understood and appropriately carried out by those of ordinary skill in the art. Therefore, it should be understood that the invention could be practiced with modification and alteration within the spirit and scope of the claims. The description is not intended to be exhaustive or to limit the invention to the precise form disclosed. It should be understood that the invention could be practiced with modification and alteration.

What is claimed is:

1. A method of processing communications signals, the method comprising:
receiving data at a first directional antenna;
determining the received data contains a first message for a first subscriber in a current cell a second message for a second subscriber in a remote cell;
providing an omni-directional antenna path for the first message;
transmitting the first message to the first subscriber through the omni-directional antenna path;
providing a directional antenna path for the second message; and
transmitting the second message to the remote cell through the directional antenna path.

2. The method of claim 1, further comprising:
determining the received data contains a third message for a third subscriber in an MMR-BS cell; and
dropping the third message.

3. The method of claim 1, further comprising:
receiving uplink data from an omni-directional antenna;
determining the uplink data contains a fourth message for a base station;
providing a directional antenna path for the fourth message; and
transmitting the fourth message to the base station through the directional antenna path.

4. The method of claim 1, wherein the act of providing the omni-directional antenna path for the first message comprises disabling the directional antenna path.

5. The method of claim 1, wherein the act of providing the directional antenna path for the second message comprises disabling the omni-directional antenna path.

6. The method of claim 1, wherein the act of transmitting the first message to the first subscriber through the omni-directional antenna path comprises scheduling the first message for future retransmission.

7. The method of claim 1, wherein the act of transmitting the second message to the remote cell through the directional antenna path comprises scheduling the second message for future retransmission.

8. An apparatus to increase the cell radius and performance of an MMR station, the apparatus comprising:
a wireless base station;
N RF directional antennas;
an N+1 rotary multi-pole RF switch having a primary pole and N+1 secondary poles, wherein the primary pole is switchable to the N+1 secondary poles, and wherein the primary pole is coupled to the base station;
N two-way RF switches each having a primary pole switchable, a first pole and a second pole, wherein the primary pole is switchable between the first pole and the second pole, wherein the primary pole is coupled to a respective one of the N RF directional antennas, and wherein the first pole is coupled to a respective one of a first N poles of the N+1 secondary poles of the N+1 rotary multi-pole RF switch;
an N-way RF power divider having a primary terminal and N secondary terminals, wherein the primary terminal is couple a last secondary pole of the N+1 rotary multi-pole RF switch, and wherein each of the N secondary terminals are couple to a respective one of the secondary poles of the N two-way RF switches; and
a controller to control sequencing of the N two-way RF switches and the N+1 rotary multi-pole RF switch.

9. The apparatus of claim 8, wherein N=3.

10. An MMR relay station for processing communications signals, the MMR relay station comprising:
means for receiving data at a first directional antenna;
means for determining the received data contains a first message for a first subscriber in a current cell a second message for a second subscriber in a remote cell;
means for providing an omni-directional antenna path for the first message;
means for transmitting the first message to the first subscriber through the omni-directional antenna path;
means for providing a directional antenna path for the second message; and
means for transmitting the second message to the remote cell through the directional antenna path.

11. The MMR relay station of claim 10, further comprising:
means for determining the received data contains a third message for a third subscriber in an MMR-BS cell; and
means for dropping the third message.

12. The MMR relay station of claim 10, further comprising:
means for receiving uplink data from an omni-directional antenna;
means for determining the uplink data contains a fourth message for a base station;
means for providing a directional antenna path for the fourth message; and
means for transmitting the fourth message to the base station through the directional antenna path.

13. The MMR relay station of claim 10, wherein the means for providing the omni-directional antenna path for the first message comprises means for disabling the directional antenna path.

14. The MMR relay station of claim 10, wherein the means for providing the directional antenna path for the second message comprises means for disabling the omni-directional antenna path.

15. The MMR relay station of claim 10, wherein the means for transmitting the first message to the first subscriber through the omni-directional antenna path comprises means for scheduling the first message for future retransmission.

16. The MMR relay station of claim 10, wherein the means for transmitting the second message to the remote cell through the directional antenna path comprises means for scheduling the second message for future retransmission.

17. An MMR relay station for processing communications signals, the MMR relay station comprising:
a receiver coupled to a first directional antenna and an omni-directional antenna, wherein the receiver comprises circuitry to demodulate signals into received data;
a processor coupled to the receiver, wherein the processor comprises logic to determine whether the received data contains a first message for a first subscriber in a current cell and to determine whether the received data contains a second message for a second subscriber in a remote cell;
a controller, wherein the controller
schedules transitions of received messages;
selects a transmission path between the omni-directional antenna path and the directional antenna path;
provides an omni-directional antenna path for transition of the first message; and
provides a directional antenna path for transition of the second message; and
a transmitter selectively coupled between the omni-directional antenna path and the directional antenna path.
